(19) United States
(12) Patent Application Publication
(10) Pub. No.: US 2007/0089354 A1
(43) Pub. Date: Apr. 26, 2007

(54) DEVICE TO BE DETACHABLY ATTACHED TO A LINE AND A METHOD FOR ITS ATTACHMENT AND DETACHMENT

(76) Inventor: Alenko Franolic, Glonn (DE)

Correspondence Address: STANDLEY LAW GROUP LLP, 495 METRO PLACE SOUTH, SUITE 210, DUBLIN, OH, 43017, US

(21) Appl. No.: 11/550,880

(22) Filed: Oct. 19, 2006

(30) Foreign Application Priority Data
Oct. 21, 2005 (DE) 20 2005 016 656.1
May 5, 2006 (DE) 10 2006 021 081.6

(51) Int. Cl. A01K 93/00; A01K 95/00

(52) U.S. Cl. 43/44.9; 43/44.87; 43/44.91

(57) ABSTRACT

Device to be attached to a line comprises a body with a through hole and at least one line receiving recess extending on the outer side of said body, wherein (a) a line retaining portion is provided for retaining the line by friction, form-fit and/or adhesion, and/or (b) the line receiving recess forms in the wall of the through hole two body binding portions having substantially rounded cross-sections. When tying-in a device according to the last mentioned second alternative (b) a line loop is threaded into the hole and the body is then rotated through the loop for achieving a line intertwist at said body.

### CROSS REFERENCE TO RELATED APPLICATION

This application claims priority to German Patent Application Serial No. 20 2005 016 656.1 filed Oct. 21, 2005 and German Patent Application Serial No. 10 2006 021 081.6 filed May 5, 2006.

### FIELD OF THE INVENTION

The present invention relates to a device and a method for its attachment to a line. The invention relates in particular to a device, for example a lead, a stopper, a float or a strike indicator to be attached to a fishing line, as well as to the kind of use, i.e. the method for tying-in the device on a line.

### BACKGROUND OF THE INVENTION

In the prior art there are known different devices and methods for its detachable mounting to a line, preferably to a fishing line.

In the document U.S. Pat. No. 4,944,107 there is known for example the design of such a device as a spherical lead. The spherical body of this device is provided with two recesses disposed opposite to each other, wherein the first one of said recesses serves for clamping the lead on a line, whereas the second one of said recesses, when squeezed provides the opening of the first one.

In the document U.S. Pat. No. 4,790,104 there is disclosed a clip-like device for detachably attaching of various angling items to a line, said device being made of wire or a metal sheet. This device has a substantially flat body with a “U”-like cut-out opening. For tying-in the line to the device a line loop is laced up into the cut-out portion first, then wound around the body and suspended on the tongue-like body portion extending into the “U”-like cut-out opening before the line ends extending from the device body are tightened and thus the body is mounted in the line.

The above loop-technique providing a tight wrapping of the device body by the line was the subject of further improvements proposed in the prior art.

From the document CA 2,089,586 there is known a device of a similar kind comprising a spherical body provided with a partially embedded wire formation. The outer portions of the wire formation comprise a first closed wire loop and a second open bended section. In order to attach the body to a line, a line loop is threaded-up into the closed loop and after being wound around the body several times then finally suspended on the second open bended section.

In the document U.S. Pat. No. 5,435,095 there is disclosed another spherical device without any wiring on it. Instead of the closed loop described above the line loop is threaded through a through hole formed in the device body and then, instead using the above mentioned open bend wire section, simply suspended on a narrowed portion of said body formed between two opposite recesses.

### SUMMARY OF THE INVENTION

It is the object of the present invention to provide an improved device to be detachably attached to a line and a method for its attachment and detachment. The invention should provide in particular optionally a temporary or long lasting tying-in of a functional body to a line being deformation free and nondestructive.

This object is achieved by a device according to each one of the independent device claims. Preferable embodiments of the device according to the invention are defined in the claims.

According to the invention there is provided a device to be attached to a line comprising a body with a through hole and at least one line receiving recess extending on the outer side of said body, wherein (a) a line retaining portion is provided for retaining the line by friction, form-fit and/or adhesion and/or (b) the line receiving recess forms in the wall of the through hole two body binding portions having substantially rounded cross-sections. When tying-in a device according to the last mentioned second alternative (b) a line loop is threaded into the hole and the body is then rotated through the loop for achieving a line intertwist at said body.

According to the above a first aspect of the invention relates to a device to be attached to a line, said device comprising a body with a through hole and at least one receiving recess extending on the outer side of said body, characterized by a line retaining portion for retaining of the line by friction, form-fit and/or adhesion.

A preferable embodiment of such a device is characterized in that at least a first opening side of said through hole merges from into said receiving recess.

According to a further preferable embodiment the device is characterized in that the line retaining portion is formed as a line locking portion comprising a narrowed portion of the receiving recess, the width of which is smaller than the widest cross section of the through hole.

Another preferable embodiment of the device is characterized in that the receiving recess forms a closed contour on the outer side of the body and extends over the two opening sides of said through hole.

A further preferable embodiment of the device is characterized by at least one engaging slot formed on the outer side of the device body, said slot crossing or merging from the side into said receiving recess.

Another preferable embodiment of the device is characterized in that the extension line of the engaging slot extends substantially perpendicular to the extension line of the receiving recess.

According to a second aspect the present invention relates to a device to be attached to a line, said device comprising a body with a through hole and at least one receiving recess extending on the outer side of the body, characterized by at least one engaging slot formed on the outer side of said body crossing or merging into said receiving recess.

A preferable embodiment of such a device is characterized in that the extension line of the engaging slot extends substantially perpendicular to the extension line of the receiving recess.

According to a third aspect the present invention relates to a device to be attached to a line, said device comprising a body with a through hole and at least one receiving recess extending on the outer side of said body, characterized in that line receiving recess forms in the body part or wall surrounding the through hole two narrowed body binding portions having substantially rounded cross-sections.

In a preferable embodiment each of these cross-sections of the body binding portions is smaller than the cross-section of the through hole which provides an easy threading of a line loop into the hole and a more firm tying of the line on the rounded body binding portions.

Particularly preferable is also an embodiment where the bottom of the line receiving recess extends close to the center-of-mass line of said body. When the line ends emerging from the device body extend within such a recess, the body remains well balanced on the line, thus avoiding bouncing.

Preferably, the body part of the device or the wall surrounding the through hole has the form of a substantially hollow cylinder, preferably the form of a flat cylinder.

A preferable embodiment of such a device is characterized in that the width of the receiving recess is smaller than the most narrow width of the through hole.

Another preferable embodiment of such the device is characterized in that the receiving recess forms a closed contour on the outer side of the body and extends over the two opening sides of the through hole thereby forming in the wall of the hollow cylinder on each opening side two indentations disposed substantially opposite to each other, said indentations being substantially axially (i.e. along the axis of the through hole) aligned with the respective indentations on the respectively other opening side.

Another preferable embodiment of the device is characterized by at least one engaging slot formed on the outer side of the body, said slot crossing or merging from the side into the receiving recess.

The object according to the invention is further achieved by the tying-in methods defined in the independent claims, by means of which methods a further measure for retaining the line to the device body is provided in addition to the friction force resulting from a mere wrapping of the device body by the line.

According to a first aspect the invention relates to a method of use of a device for being attached to a line, said device comprising a body with a through hole and at least one receiving recess extending on the outer side of said body, wherein in this use in addition to accommodating a portion of the line in the receiving recess there is provided at least one line intertwist directly at or in the body. By means of such at least a partial intertwist of line portions a reliable attachment of the line wrapped on the body it is provided even in the case of unfavorable line characteristics and extreme line load. Such an intertwist does not impair the tensile strength of the respective line part since it actually does not represent a conventional knot. What is understood here as an intertwist is a direct force transmitting engagement of line portions in each other.

A preferable embodiment of the use according to the invention is characterized by the steps:

sliding on the body by means of his through hole on a loop formed in a part of said line so that the loop emerges from one of the hole openings;

widening said loop until his ends merging into the hole become parallel to a body axis, while the line ends emerging from the other one of said openings become spread also in parallel to said axis;

turning the body at more than 180° around its axis of step and in the same time through the loop in order to achieve an intertwist of the merging loop ends with the emerging line ends;

laying the middle loop portion into the receiving recess; and

pulling in opposite directions the emerging line ends until tightening the body in the line.

For the purposes of this use all of the above described devices can be taken. The angle of rotation of the body through the loop depends on the location of the receiving recess in relation to the through hole and on the desired level of line intertwist.

According to a second aspect the invention relates to a use

of a device for being attached to a line, said device comprising a body with a through hole and at least one receiving recess extending on the outer side of said body, wherein in this use in addition to arranging the line close at or in the device body there is provided at least one additional retention of the line wound around the body by friction, form-fit or adhesion. This can be achieved optionally by a respective form of the line receiving recess, an appropriate material of the body and/or by additional elements in or at the receiving recess.

The object of the invention is achieved also by method for disentanglement and removing of a device from a line.

According to a first aspect of such a method a tiny tool is introduced into the through hole of a device having a hollow cylindrical body in order to push out of the hole the middle part of the tightened loop extending above between the indentations of the cylindrical body wall and thus re-open the loop. Then the line is disentangled by back-tracking the steps (d) to (a) and finally removed from the device body.

According to a second aspect of a method for disentanglement and removing of a device from a line, a spiky tool is introduced into an engaging slot crossing or merging into the line receiving recess and pulled substantially along the axis of the through hole in order to open the middle part of the tightened line loop extending between the indentations. The line is subsequently disentangled by back-tracking the steps (d) to (a) and finally removed from the device body.

The methods for attachment and detachment of a device according to the invention to/from a line described above are applicable also by devices, where the line is not subject of intertwist, but only wound around the device body and accommodated into the receiving recess where the line is retained by friction, form-fit or adhesion.

In the following the invention is further explained by embodiments as examples with reference to the Figures where:

### BRIEF DESCRIPTION OF THE DRAWINGS

FIG. 1 is a top view of a first embodiment of the device according to the invention;

FIG. 2 is a cross-sectional view of the device in FIG. 1 through the line A-A;

FIG. 3 is a top view of a second embodiment of the device according to the invention;

FIG. 4 is a cross-sectional view of the device in FIG. 3 through the line B-B;

FIG. 5 is a side view of a third embodiment of the device according to the invention;

FIG. 6 is a top view of the device in FIG. 5

FIG. 7 is a top view of a forth embodiment of the device according to the invention;

FIG. 8 is a cross-sectional view of the device in FIG. 7 through the line A-A;

FIG. 9 is a cross-sectional view of the device in FIG. 7 through the line B-B;

FIG. 10 is a three-dimensional view of the device in FIG. 7;

FIG. 11 is a top view of a fifth embodiment of the device according to the invention;

FIG. 12 is cross-sectional view of the device in FIG. 11 through the line A-A;

FIG. 13 is a cross-sectional view of the device in FIG. 11 through the line B-B;

FIG. 14 is a three-dimensional view of the device in FIG. 11;

FIG. 15A to 15D each represents a three-dimensional view of a sixth embodiment of the device according to the invention for illustrating the different entangling phases for attaching the device to a line;

FIG. 16B, 16D is a three-dimensional view of a seventh embodiment of the device according to the invention illustrating two particularly characteristic phases of its entanglement for attaching the device to a line.

### DETAILED DESCRIPTION OF THE INVENTION

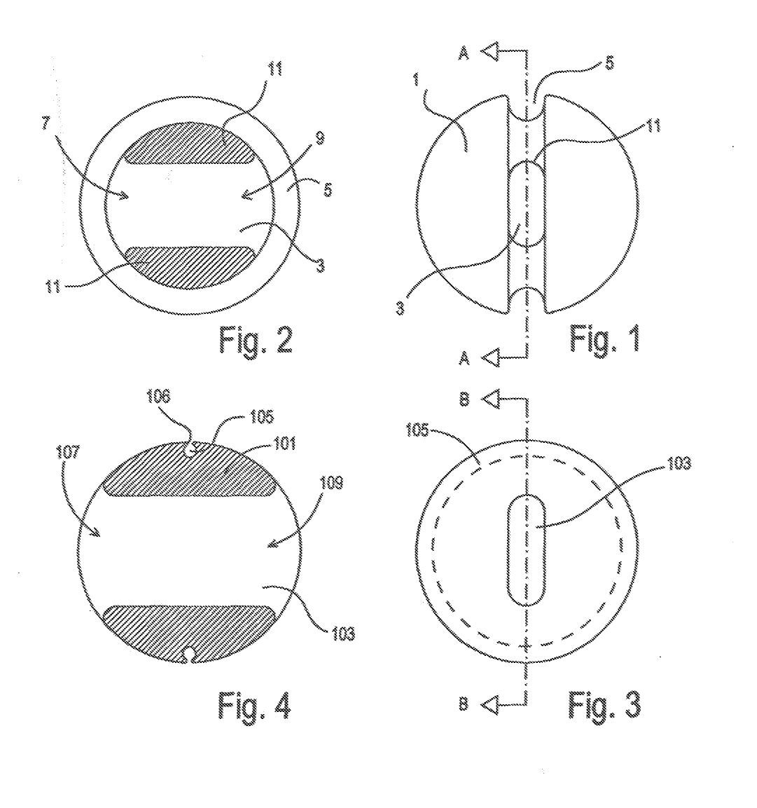

A first embodiment of the device according to the invention is shown in FIGS. 1 and 2. The device comprises a substantially spherical body 1 being manufactured of a tungsten compound material. In the body there is provided a through hole 3 the cross-section of which is not circular, but elongated in a direction illustrated in FIG. 1 by the line A-A. In this direction a circumferential receiving recess 5 having a substantially circular cross-section is formed on the outer side of the body. The openings 7 and 9 of the through hole are each provided with a rounded edge 11. A substantial characteristic of this embodiment consists in that the openings 7 and 9 merge into the receiving recess 5.

The device according to the invention can be also manufactured as illustrated by a second embodiment shown in FIGS. 3 and 4. Unlike the first embodiment the receiving recess 105 of the body 101 is formed here outside the openings 107, 109 of the through hole 103 and is provided with a narrowing portion 106. This narrowing portion serves for retaining the line in the receiving recess 105 particularly in a case where the line loop drawn through the hole 103 is merely suspended in the receiving recess 105 without being subject of intertwist as shown below in the FIGS. 15A to 15D. In such a case the closed contour of the receiving recess used here should preferably extend in a plane inclined to the axis of the through hole and cutting one of the openings 103 or 107.

The width of the narrowing portion 106 is preferably by 0.01 to 0.05 mm smaller than the line thickness in order to enable an elastic squeeze of the line into the receiving recess.

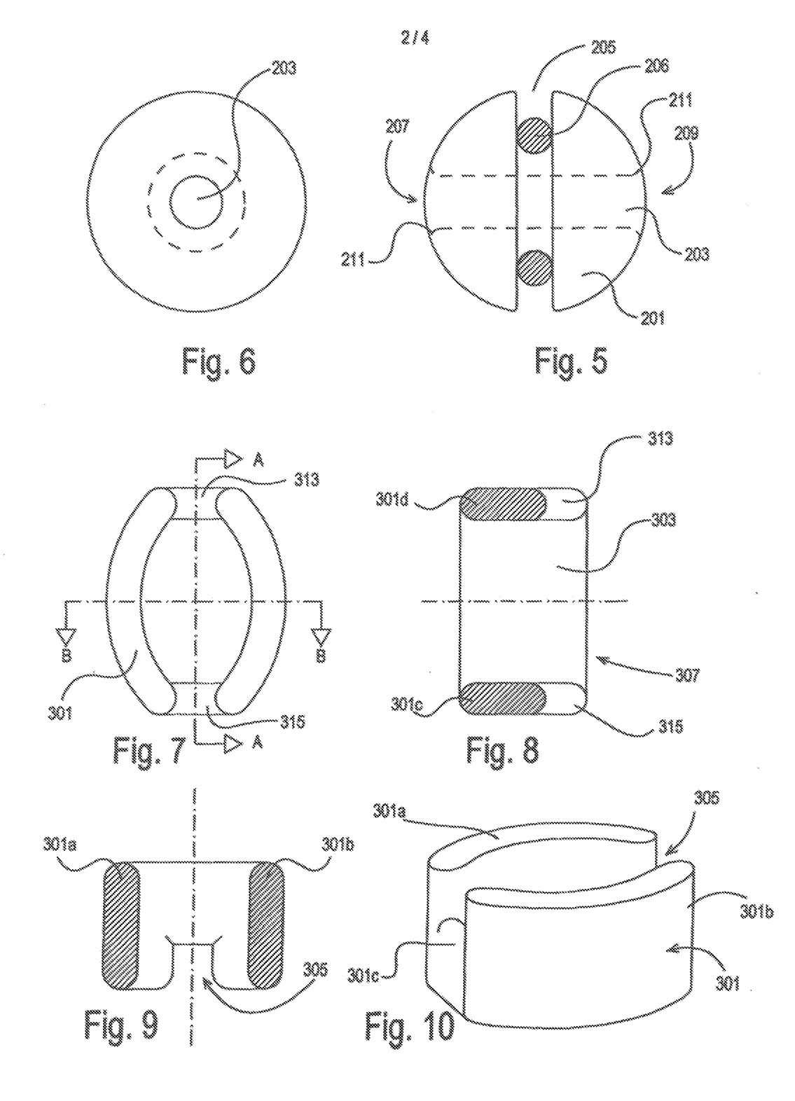

A third embodiment of the device according to the invention is shown in FIGS. 5 and 6. This embodiment differs from the second embodiment substantially by the higher depth of the receiving recess 205 and the circular cross-section of the through hole 203. According to this third embodiment the body 201 is manufactured by pressing of tungsten powder material. As this is the case also in the second embodiment the openings 207 and 209 of the through hole 203 are provided each here with a rounded edge 211. For retaining the line to be accommodated in the receiving recess 205 there is provided a rubber ring 206 mounted under initial tension in the receiving recess 205. The rubber ring provides a frictional coupling with the line when as a result of the tightening of the loop the line penetrates between the rubber ring 206 and the body 201.

Instead of the rubber ring or in addition thereto a material having adhesive properties in relation to the body and the line can be applied in the receiving recess.

A fourth embodiment of the device according to the invention is shown in FIGS. 7, 8, 9 and 10. This device has a substantially flat and hollow cylindrical body 301 being manufactured from a tungsten containing compound material. Hence, the through hole 303 of the body is formed bigger compared to the preceding embodiments and has an elongated form. As shown in FIG. 7 the receiving recess 305 according to the present invention extends along the cutting line A-A and forms on the first opening side 307 of the through hole 303 two indentations 313 and 315 being arranged opposite to each other along the line A-A. By means of the indentations the body 301 is subdivided into two shells 301a and 301b being connected to each other by two fixed links 301c and 301d serving as body binding portions. The cross-sections of these elements are all rounded in order to prevent a wearing through or an extraordinary deformation of the line being in contact with them. In the same way as in the preceding embodiments the junction between the first opening 307 and the receiving recess or the indentations 313, 315, respectively, is rounded.

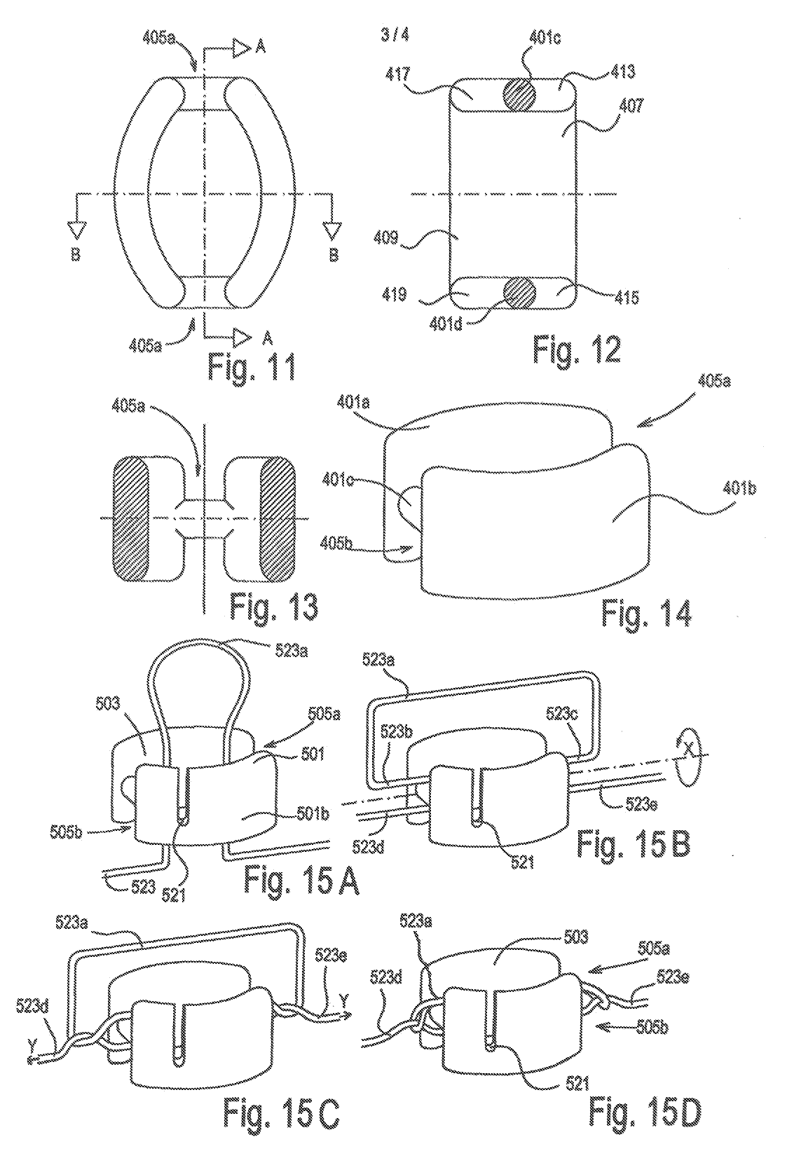

A fifth embodiment of the device according to the invention is shown in the FIGS. 11, 12, 13 and 14. The body of this device is formed substantially in the same way as the body according to the fourth embodiment with the difference that also the second opening side 409 of the through hole is provided with two indentations 417 and 419 being arranged substantially opposite to each other. These indentations are aligned with the indentations 413 and 415 on the first opening side 407 substantially along the axis of the through hole.

The flat cylindrical body 401 is manufactured from a tungsten containing compound material. As shown in FIG. 14 the receiving recess according to the invention consists of two separate portions 405a and 405b. In this embodiment the first portion 405a on the first opening side 407 of the through hole 403 forms in the wall of the flat cylindrical body two indentations 413 and 415 being disposed opposite to each other. By means of the four indentations 413 to 419 also the body of this embodiment is subdivided into two shells 401a and 401b being fixedly connected to each other by two fixed links 401c and 401d serving as body binding portions. The cross-sections of the fixed links 401c and 401d are formed in a circular shape in order to prevent a wearing through or an extraordinary deformation of the line being in contact with the links. In the same way as in the preceding embodiments the junctions between the openings 407 and 409 and the portions 405a and 405b of the receiving recess or the indentations 413 to 419, respectively, are rounded.

An example for the use according to the invention, in particular for the attaching the device by tying-in its body to a line, is explained in the following with reference to a sixth embodiment of the device according to the present invention shown in FIGS. 15A to 15D. This embodiment is substantially the same as the fifth embodiment with the additional feature that an engaging slot 521 is formed in one of the shells 501b of the body 501 which slot crosses the extension line of the receiving recess 505a. The engaging slot 521 is deeper than the receiving recess 505a. As shown in the Figures of this embodiment the line of the engaging slot 521 extends substantially perpendicular to the extension line of the receiving recess 505a.

The device according the sixth embodiment of the invention is used for attaching its body 501 to a line 523 as follows:

As a first step a loop 523a is formed in the line and subsequently inserted into the through hole 503 until it clearly emerges from the opening of the through hole at the side of the receiving recess 505a as shown in FIG. 15A. Then, as shown in FIG. 15B the loop 523a is widened so far that its ends protruding in the through hole are stretched substantially in parallel to a center-of-mass axis X of the body, wherein also the line portions 523d, 523e emerging from the other opening side of the through hole are stretched in parallel to that same axis. This can easily be achieved by the fingers of the right and left hand. In this step the emerging line portions 523d, 523e enter the receiving recess 505b on this opening side.

Next, the body is rotated by 360° around the axis X and thereby turned through the loop 523a in order to intwist the merging ends 523b, 523c with the emerging line portions 523d, 523e as shown in FIG. 15C.

Finally, the middle portion of the loop 523a is inserted into the receiving recess 505a and the line portions 523d and 523e emerging from the other opening side of the through hole are stretched as shown in FIG. 15D.

In order to disentangle and remove the device according to the invention from the line 523 a spiky tool, for example a hook-eye needle, is inserted into the engaging slot 521 from the side of the body so deep further into the through hole 503 until it arrives behind the middle portion of the loop 523a. Then the hook-eye needle is pulled substantially along the axis of the through hole in upward direction in FIG. 15D in order to push-out the middle portion and re-open the loop. Subsequently the steps shown in FIGS. 15C to 15A and already described above are carried out in this order backwards in order to disentangle the body 501 from the line 523 and finally to remove the body from the line.

The devices according to the invention and the method of use explained above are preferably applied for tying-in a lead, a visualizing part (strike indicator), a stopper and/or a float to a fishing line. However also other functional fishing items and accessories can be attached in this way to a line and when necessary removed therefrom without thereby creating a damaged line portion having a diminished tensile strength.

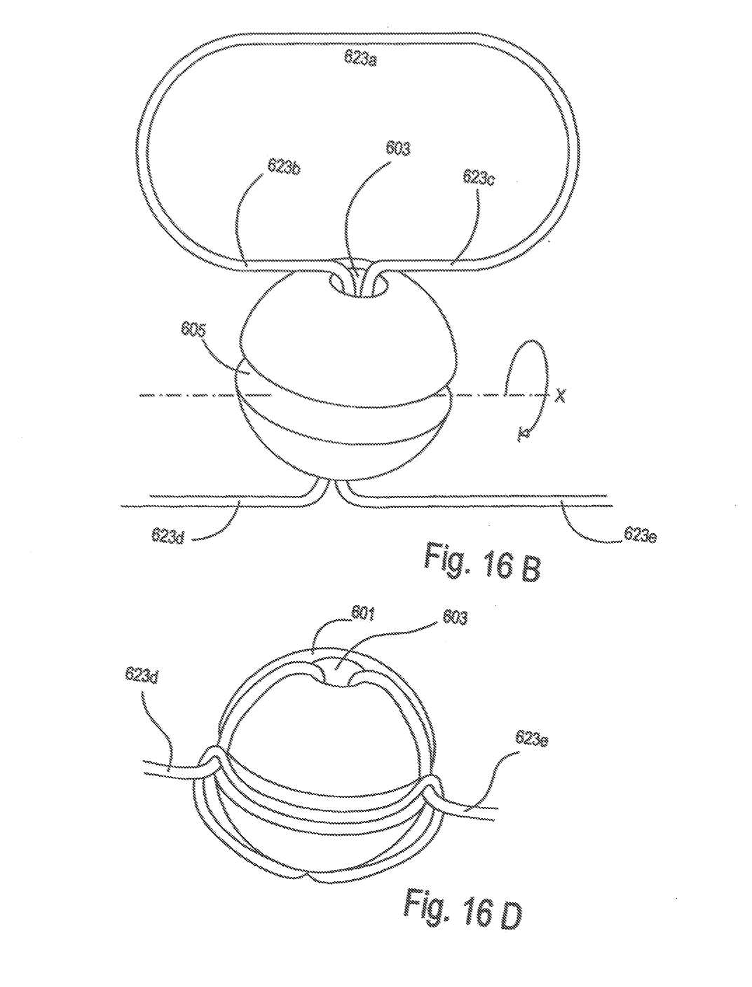

The choice of an appropriate body form, the position of the through hole and after all the position of the receiving recess can be optimized depending on the particular kind of use of the device according to the invention. The body form shown in the FIGS. 7 to 15D is for example particularly appropriate for the use of the device as a fishing lead, because by appropriately adjusting the dept of the receiving recess or recesses the stretched line, i.e. the line connecting the emerging line portions 523d, 523e can be guided through the gravity center of the body in order to prevent a tumbling of the lead on the line. This can be achieved in the embodiment shown in FIGS. 16B and 16D by forming the ring-like receiving recess in a plane including the gravity center of the spherical body 601.

The kind of attachment of the device according to the invention by tying-in of its body in a line described above with reference to the FIGS. 15A to 15D can be applied to all of the device embodiments described above. In this regard it is to be emphasized that the present kind of attachment can be adapted where appropriate without thereby departing from the scope of the invention. For example, the body 1, 101, 201, 301, 401, 501 can be rotated through the line loop by more or less than a full turn.

FIGS. 16B and 16D show a respective example using a device substantially the same as the device according to the third embodiment merely lacking the ring 206. The body 601 of this device is rotated here only by 270° around the axis X and through the loop 623a. By shifting up the position of the portion of the receiving recess 605 being visible on the these figures closer to the shown opening of the through hole 603, the rotation angle of the body being necessary for achieving a minimum twisting can be reduced down to not much more than 180°.

The invention is not limited to the embodiments related to the design of the device and its use mentioned above.

It has to be emphasized that the method for attaching of a device to a line specified in the independent use claim is not limited to the particular devices described and claimed in the present application. For this use every one device is suitable the body of which has at least one through hole and at least one receiving recess formed in the body. For this use it does not matter as to whether the hole is a straight one or curved, or as to whether the receiving recess represents a closed contour or not.

On the other side, the devices described and claimed in this application do not compulsory require the use of a method for their attachment to a line in which a line twisting is indispensable.

A sensible modification of the first embodiment consists for example in that, the through hole is almost as wide as, but not more than the thickness of a loop to be inserted therein, i.e. a thickness of the double square section of the line, while the circumferential recess is formed sufficiently wide and deep in order to completely accommodate not only a single line, but also the twisted line portions resulting from the tying-in of the body to the line. Thus, an abrasion of the line can be prevented in an efficient way.

In all embodiments the form and/or width and/or equipment of the receiving recess accommodating during the tying-in at least a portion of the line can be dimensioned depending on the line thickness such that an efficient attachment of the respective line portion or a plurality of line portions arranged next to each other can be provided following the example of the embodiments shown in FIGS. 3 to 6.

Although being preferable, the provision of an engaging slot in devices having a substantially hollow cylindrical body is not absolutely necessary, since the line portion being tightened within the receiving recess can be pushed out in order to re-open the line loop merely by reaching into the through hole. Unlike this situation an engaging slot is particularly efficient in the case of the first three embodiments where the through hole is relatively tight, thus preventing a tool of being inserted therein.

Also the substantially hollow cylindrical body being typical for certain embodiments can be modified in an arbitrary way. The body of a device according to the invention can be formed out of a thin slice from a rectangular hollow profile tube having an extremely flattened square section. Such an elongated form of the body is particularly appropriate for its application as a lead to be attached to a fishing line in order to prevent tumbling or hang-ups of the line on items in the water.

With regard to the materials used for the device modifications are possible as well. For example in cases where the device according to the invention is used as a fishing lead, instead of tungsten powder containing compound material a stainless steel or—if allowable—also lead can be used. For the use of the device according to the invention as a stopper different floating and non-floating plastic materials as well as rubber and other elastic materials are of interest. For the use of the device according to the invention as a strike indicator on the leader of a fly fishing line the application of foam materials is of advantage, said materials being either connected to the relatively rigid device body or directly serving as body material.

1. Device to be detachably attached to a line, said device comprising a body with a through hole and at least one line receiving recess extending on the outer side of said body, characterized by a line retaining portion for retaining the line by friction, form-fit and/or adhesion.

2. Device according to claim 1, wherein the bottom of said line receiving recess extends close to the center-of-mass line of said body.

3. Device according to claim 1 or 2, wherein the receiving recess forms a closed contour on the outer side of the body and extends over the two opening sides of said through hole.

4. Device according to one of claims 1 or 2, characterized by at least one engaging slot formed on the outer side of said body, said slot crossing or merging from the side into said receiving recess.

5. Device to be attached to a line comprising a body with a through hole and at least one line receiving recess extending on the outer side of said body, wherein said line receiving recess forms in the wall of said through hole two narrowed body binding portions having substantially rounded cross-sections.

6. Device according to claim 5, characterized in that each of the cross-sections of said body binding portions is smaller than the cross-section of said through hole.

7. Device according to claim 5 or 6, characterized in that the bottom of said line receiving recess extends close to the center-of-mass line of said body.

8. Device according to one of claims 5 or 6, characterized in that the wall surrounding the through hole has the form of a substantially hollow cylinder.

9. Device according to one of claims 5 or 6, characterized by at least one engaging slot formed in the wall, said slot crossing or merging from the side into said receiving recess.

10. The use of a device for being attached to a line, said device comprising a body with a through hole and at least one receiving recess extending on the outer side of said body, characterized in that in addition to accommodating a portion of said line in the receiving recess there is provided at least one line intertwist at said body.

11. The use according to claim 10, characterized by the steps:
(a) sliding on the body by means of his through hole (503; 603) on a loop (523a; 623a) formed in a part of said line so that the loop emerges from one of the hole openings;
(b) widening said loop until his ends (523b, 523c; 623b, 623c) merging into the hole become parallel to a body axis (X), while the line ends (523d, 523e; 623d, 623e) emerging from the other one of said openings become spread also in parallel to said axis;
(c) turning the body at more than 180° around its axis (X) of step (b) and in the same time through the loop (523a; 623a) in order to achieve an intertwisting of the merging loop ends (523b, 523c; 623b, 623c) with the emerging line ends (523d, 523e; 623d, 623e);
(d) laying the middle loop portion (523a; 623a) into the receiving recess; and
(e) pulling in opposite directions the emerging line ends (523d, 523e; 623d, 623e) until tightening the body in the line.

12. The use according to claim 10 of a device according to one of claims 1, 2, 5, or 6.
